(19) United States
(12) Patent Application Publication
(10) Pub. No.: US 2024/0123549 A1
(43) Pub. Date: Apr. 18, 2024

(54) Method For Laser Welding, And Welded Construction Produced Thereby

(71) Applicant: Kirchhoff Automotive Deutschland GmbH, Attendorn (DE)

(72) Inventors: Jan STUHRMANN, Drolshagen (DE); Christian DAHMEN, Olpe (DE)

(21) Appl. No.: 18/547,196

(22) PCT Filed: Feb. 22, 2022
(86) PCT No.: PCT/EP2022/054352

§ 371 Date: Aug. 21, 2023

(30) Foreign Application Priority Data
Feb. 23, 2021 (DE) 10 2021 104 305.0
Mar. 22, 2021 (DE) 20 2021 101 463.6

(51) Int. Cl. B23K 26/26; B23K 26/00

(52) U.S. Cl. CPC B23K 26/26; B23K 26/0006; B23K 2101/006

(57) ABSTRACT

A description is given of a method for the laser welding of two parts to be joined (1) that are positioned in relation to one another, in which method the laser head, with the laser beam (9) emitted from it, and the two parts to be joined (1), with the joint (3) thereof, are moved in relation to one another in a feeding direction along the longitudinal extent of the joint (3) and the laser beam (9) produces in the joint (3) a weld seam with a target welding-in depth (8) which is deeper than the critical welding-in depth of the parts to be joined (1), wherein the welding method is performed in two steps and, to form the weld seam connecting the two parts to be joined (1), in a first step material in the joint (3) is melted by the laser beam (9) down to the target welding-in depth (8) and wherein, in a subsequent step, the weld seam produced by the first step is melted once again down to a welding-in depth which, as a maximum, corresponds to the critical welding-in depth of the parts to be joined (1). A description is also given of a welded construction (11) produced by this method.

The invention relates to a method for the laser welding of two parts to be joined, that are positioned in relation to one another, in which method the laser head, with the laser beam emitted from it, and the two parts to be joined, with the joint thereof, are moved in relation to one another in a feeding direction along the longitudinal extent of the joint and the laser beam produces in the joint a weld seam with a target welding-in depth which is deeper than the critical welding-in depth of the parts to be joined. Also described is a welded construction, in particular as a subassembly for a vehicle, at least partially produced by this method.

In many areas of metal construction technology, two parts to be joined are joined together by laser welding. One of the technical areas in which laser welding methods are used is the automotive sector, specifically in connection with body construction as well as for the manufacture of support constructions, beams and the like. In the latter case, laser welding is used, among other things, when the constructions to be produced are welded constructions, i.e. constructions that are assembled from several prefabricated individual parts to form a welded construction and the individual parts are joined together by welding. In such cases, laser welding is generally carried out without any welding material additions. This proves to be more cost-effective than the formation of laser welds with welding material additions. In addition, there are technical advantages such as better accessibility and deeper welding-in depths. Another advantage of laser welding is that only a relatively small area of the two parts to be joined is heated by welding, so that the heat-affected zone can be kept small. This is particularly desirable for components that have been hardened before joining or that require low distortion.

However, laser welding without welding material addition requires that the two parts to be joined are held relative to each other for the purpose of welding in such a way that the joint has a so-called zero gap or an almost zero gap. For this purpose, the parts to be joined are positioned relative to one another and held in a clamping device under a preload acting on the joint. This is required for ensuring that the joint located between two parts to be joined meets the requirements placed on a joint to be welded by laser. For this reason, such a clamping device applies comparatively high forces to the parts to be joined at the joint. In the case of multidimensionally shaped welded constructions, for example if they have curved surfaces as is the case, for example, with bumper crossmembers, it cannot be prevented that the clamping force applied, which basically acts on the joint as a compressive force, also generates tensile forces at certain points or in certain portions. The reason for this can be tolerances in the outline geometry of the parts to be joined as well as leverage effects due to the weld construction as such. For laser welding, the laser head with the laser beam emitted from it is moved relative to the two parts to be joined with the joint. Typically, the laser head is moved while the parts to be joined held in the clamping device remain stationary relative to the laser head. The laser welding is performed with such an energy that the laser beam reaches the welding-in depth intended for joining the two parts to be joined—the target welding-in depth.

The problem with laser welding without welding material addition is that above a critical welding-in depth, which depends among other things on the material and the material condition of the parts to be joined, there is normally the risk that cracks—so-called hot cracks—will form within the weld seam. This is attributed to the tensile stresses that sometimes occur in the joint, which do not allow the hardening melt to completely coalesce during solidification. Interestingly, such cracks do not necessarily extend to the surface of the weld seam and thus often remain externally undetected. They form above the critical welding-in depth. In particular, the production of even numerous metallographic micrographs does not always reveal them, and they are therefore not detected. In order to reliably produce a welded construction that meets the requirements placed on it, especially with regard to the weld seam, it is necessary to carry out a large number of weld tests with different welding parameters and weld test evaluations until the weld results show as few such cracks as possible. Cracks present in the weld seam, especially if they are undetected, impair the weld seam, which then, as a matter of course, does not meet the requirements placed on it. In this context, it is worth mentioning that, normally, the specified welding-in depth for such welded constructions is greater than the critical welding-in depth. If the welding-in depth is less than or equal to the critical welding-in depth, hot cracks do not form in the weld.

Even if hot cracking can be reduced by appropriate parameterization of the laser, such as its focus, energy and feed rate, hot cracking cannot ultimately be avoided in the context of reliable industrial production. This is particularly true when the parts to be joined are made of materials such as high-strength steel or special aluminum alloys with unfavorable Si and/or Mg contents. Such materials are characterized by a particularly high susceptibility to hot cracking.

Based on the discussed prior art, the object of the invention is therefore to propose a method for laser welding, in particular without welding material addition, of two parts to be joined positioned relative to one another, with which method the two parts to be joined can be joined with a target welding-in depth which is deeper than the critical welding-in depth, while still ensuring that the weld seam is free of hot cracks even when the two parts to be joined are made of high-strength material.

According to the invention, this object is achieved by the generic method mentioned at the beginning, in which the welding method is performed in two steps and, in order to form the weld seam connecting the two parts to be joined, in a first step material in the joint is melted with the laser beam down to the target welding-in depth and wherein, in a subsequent step, the weld seam produced by the first step is melted once again down to a welding-in depth which, as a maximum, corresponds to the critical welding-in depth of the parts to be joined.

While in conventional laser welding of two parts to be joined, which are mainly made of material at risk of hot cracking, all possible compromises are made in order to try to keep hot cracking in the weld seam as low as possible, a different approach is taken in the claimed method. The welding method is carried out in two steps. After a first welding step and after solidification of the molten metal melted by this welding step, this first weld seam or weld zone is passed over again by the second welding step. Compromises that affect the efficiency of laser welding and thus productivity do not have to be made with this method. In this laser welding method, in a first step, a weld seam with a welding-in depth down to the target welding-in depth is created, without the need for special measures to reduce hot cracking. This gives much greater freedom in the choice of welding parameters. Therefore, the welding parameters can be set in a way that is optimal for the weld to be produced. The welding parameters are typically set in such a way that hot cracking is accepted, but an attempt is made to form it as close to the surface as possible, i.e. at a depth that is less than the critical welding-in depth. For the reasons mentioned, this welding can also be carried out at relatively high feed rates. In order to reduce the formation of hot cracks, conventional methods have endeavored to keep the feed rate as low as possible, but this is disadvantageous in terms of productivity. Thus, in this laser welding method, the formation of hot cracks is simply accepted in the first welding step, contrary to the prevailing teachings. This is possible because, according to the invention, the first welding step is followed by a further welding step in which the previously produced weld seam is partially re-melted, at most to the critical welding-in depth of the parts to be joined. This renewed melting heals any cracks that have formed, with the result that a laser weld seam free of hot cracks is produced over the entire length of a joint of the two parts to be joined. The shallower welding-in depth in the second welding step is achieved by applying less energy locally to the surface to be melted than in the first welding step.

Even if, in principle, a single lower-energy pass over the first weld seam in the second welding step is considered sufficient to heal hot cracks contained therein, it may be necessary, especially in the case of weld seams with higher welding-in depths, to carry out one or more intermediate welding steps before the final welding step, which, according to requirements, is the second welding step with which hot cracks are finally healed. In each of these intermediate steps, material from the previously created weld seam is melted. These intermediate steps, during which hot cracks can also occur, bring them successively closer to the surface and thus to shallower depths until the hot cracks are healed by the final, actual second welding step.

The first and at least one subsequent welding step can be carried out with one and the same laser head or with two laser heads. When using two laser heads, a first laser head will provide a laser beam with a higher energy per unit area and the second laser head will provide a laser beam with a lower energy. Both heads can be moved together relative to the joint, wherein the laser head whose laser beam has a lower energy follows the first laser head with its higher energy laser beam. Both laser heads can be mounted on one and the same laser head holder.

One and the same laser head can also be used for two-step laser welding according to the invention. In principle, it is possible to move the laser head along the joint with a first energy per unit area of its laser beam for performing the first laser welding step. In order to heal cracks, the laser head is then moved with a lower energy per unit area over the entire length of the weld formed by the first welding step. In the case of a laser beam operated at constant energy, this lower specific energy can be realized, for example, by a faster feed rate and/or by greater defocusing.

In a preferred embodiment, when using one and the same laser head for performing the two welding steps, it is provided that the laser head is moved continuously in the feeding direction relative to the joint and that the laser beam, starting from an initial position which typically defines an end point of an oscillatory movement of the laser beam, is brought into an oscillatory movement in the opposite direction relative to the feeding direction. In the context of the present embodiments, an oscillating movement in the opposite direction to the feeding direction means that the oscillating range of the laser beam lies to a greater extent in the opposite direction to the feeding direction with regard to a perpendicular impingement of the laser beam on the joint. For example, one of the end points of the oscillation movement can be the perpendicular impingement of the laser beam on the joint, so that the entire oscillation range, starting from this point, lies opposite to the feeding direction. The end point pointing in the feeding direction can also lie slightly in front of this point. It is also possible for the entire oscillation range to be spaced from the point of perpendicular impingement of the laser beam on the joint in the direction opposite to the feeding direction. This oscillating movement of the laser beam is thus superimposed on the feed rate of the laser head relative to the joint. During such an oscillation, the laser beam is initially swiveled from its starting position against the feeding direction and then back to its starting position. The initial position can be, for example, the position of the laser beam in which it is directed perpendicularly to the joint as seen in the direction transverse to the feeding direction. According to a preferred exemplary embodiment, this position of the laser beam also represents the end point of the oscillation movement pointing in the direction of the feed. The oscillation of the laser beam from its starting position against the feeding direction with continuous feed represents the first step of the welding method, i.e. the step in which the joint is melted by the laser beam down to the target welding-in depth. The oscillation speed and the feed rate are matched to each other in such a way that the target welding-in depth is reached during this oscillation movement. Since the laser beam oscillates back to its starting position in the direction of the weld feed, i.e. the laser beam ultimately follows the starting point further away due to the continuous feed, the speed of the laser beam over the surface of the previously created weld seam is greater than when oscillating against the feeding direction. Consequently, despite the constant laser energy, less energy is introduced locally into the weld seam due to the higher feed rate, so that the welding-in depth is reduced accordingly. Thus, the swinging back of the laser beam in the feeding direction in the oscillating movement described above represents the second step of laser welding. The oscillating movement and thus the speed of the laser beam moved by the oscillation is higher than the feed rate with which the laser head is moved relative to the joint.

The welding parameters will be set depending on the welding requirements. As already mentioned, the quality of the weld does not need to be affected by the parameters to be accepted in order to avoid the formation of hot cracks. In many embodiments, the oscillation frequency of the laser beam will be selected between 2 Hz and 70 Hz, preferably between 5 Hz and 50 Hz.

The oscillation amplitude of the laser beam is also adjustable. Preferably, this amplitude is not less than 50% of the target welding-in depth. If the oscillation amplitude and the oscillation frequency are selected too low, the second welding step follows the first welding step too quickly, so that cracks have not yet formed due to the lack of hardening of the material melted by the first welding step.

The laser welding method described above is particularly suitable for the manufacture of welded constructions which are produced without the addition of welding material and for the production of which high welding rates are required, as is desired in series production of welded constructions. One example of such welded constructions is represented by hollow section beams, such as those used in connection with weight reduction in the automotive sector, for example in the bodywork area. This also includes beams such as cross members of bumpers. These are sometimes designed as welded constructions. Such welded bumper cross members are known, for example, from DE 2009003 526 U1 or EP 3 137345 B1. In these welded constructions, two transverse plates are located between two outer plates—a front plate and a rear plate. The abutments of the transverse plates adjoin a side face facing the other outer plate. Each transverse plate thus forms a T-joint with the front and rear outer plates. A hollow chamber profile is thus formed. The advantage of such a welded construction is that different cross member geometries can be easily realized by varying the components involved in the welded construction. For example, the transverse plates can be curved at the front, with a different radius of curvature than their end facing the rear plate, in such a way that the transverse plate has a greater width in the middle section than in its end sections. Consequently, the cross-sectional geometry of such a hollow section beam is larger in its central region than in its end portions. Particularly in the case of safety-relevant assemblies, such as a bumper crossmember, a weld seam must meet the corresponding requirements and in particular must not exhibit any hot cracks. The method according to the invention is therefore particularly suitable for the production of welded constructions that are subject to safety-relevant requirements. It is quite essential in this respect that the method described can ensure freedom from hot cracks without the need for costly weld seam examinations for production quality control.

The invention is described in the following with reference to the attached figures, from which further findings and advantages of the invention can be obtained. In particular:

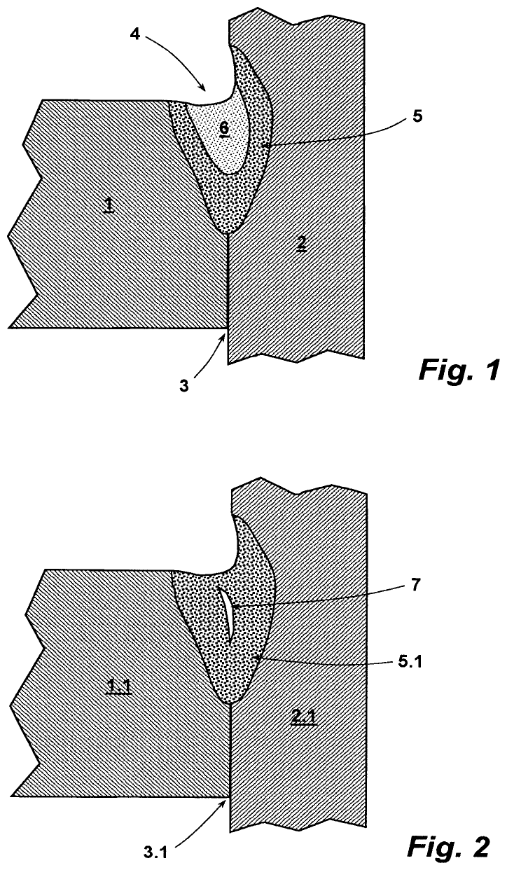

FIG. 1 shows a weld seam located in a T-joint, produced by the welding method according to the invention, in a cross-section through the joint of the two parts to be joined,

FIG. 2 shows a weld seam in a T-joint, produced with a conventional welding method, in a cross-section through the joint of the two parts to be joined,

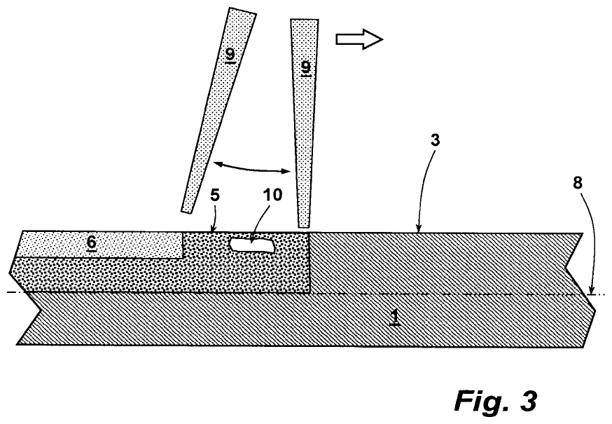

FIG. 3 shows a schematic representation of the welding method according to the invention, looking in the direction of the joint of the left-hand part to be joined, shown in FIG. 1, and

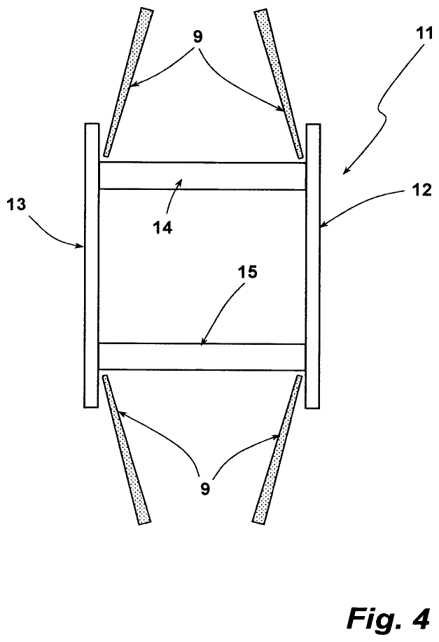

FIG. 4 shows a side view of a welded hollow-chamber profile beam as a bumper crossmember.

FIG. 1 shows two parts to be joined 1, 2, which adjoin each other to form a T-joint. The material thickness of the two parts to be joined 1, 2 is different. While the part to be joined 1 has a material thickness of 6 mm, the part to be joined 2 has a material thickness of 3 mm. The two parts to be joined 1, 2 are welded together in the region of the joint—the T-joint—starting from one side of the part to be joined 1. The finished weld seam is indicated in FIG. 1 by the reference numeral 4. The weld seam 4 is the result of a two-step laser welding method performed in the embodiment shown, in each case without welding material additions. In a first welding step, the joint 3 is melted by a laser beam down to the desired target welding-in depth. The heat penetration zone into the two parts to be joined 1, 2 is in particular very small. The weld zone 5 formed by this first welding step is melted by a second, subsequent welding step with lower linear energy to form a second weld zone 6 in which the material of the first weld zone 5 has been melted again. For this reason, the second weld zone 6 is located within the first weld zone 5. Due to the lower linear energy, the welding-in depth in the second step is significantly lower. In the example shown in FIG. 1, the welding-in depth of weld zone 6 is less than the depth of the critical welding-in depth. In the second welding step, hot cracks formed in weld zone 5 created by the first welding step are healed by the renewed melting of the material. The finished weld 4 is thus free of hot cracks.

FIG. 2 shows in a comparison with FIG. 1 the two parts to be joined 1, 2 laser-welded using conventional laser welding. Hot cracks form in weld zone 5.1 because this zone has a target welding-in depth that is deeper than the critical welding-in depth. Such a hot crack is indicated by reference numeral 7. The hot crack 7 shown in cross-section in FIG. 2 has a certain extent in the longitudinal direction of the joint 3.1. Typically, such hot cracks 7 do not extend to the surface of the weld zone 5.1, so that they are not visible from the outside. The weld zone 5 of the weld seam 4 may well show hot cracks after the first welding step has been carried out, as shown in FIG. 2 for the prior art.

In the exemplary embodiment shown, the weld seam 4 with its two weld zones 5, 6 is created with one and the same laser, namely with a feed rate of 2-5 m/min, which is usual for a production of welded constructions in series production. It goes without saying that for geometrically different components and/or components with smaller required welding-in depths, welding speeds greater than 5 m/min can also be realized. The laser welding method for producing the weld seam 4 is shown in schematic form in FIG. 3. In this figure, the target welding-in depth 8 is indicated by a dashed line within the joint of the part to be joined 1. A laser beam 9 is shown schematically in this figure. The laser head generating the laser beam 9 moves relative to the parts to be joined 1, 2 along the joint 3 in the feeding direction indicated by the block arrow. In this figure, the laser beam 9 is shown in its two end positions of an oscillating movement superimposed on the feed movement of the laser head relative to the parts to be joined 1, 2. These two positions of the laser beam 9 also define the oscillation amplitude of the laser beam 9. In the embodiment example shown, the oscillation amplitude is 3 mm. In the right end position shown in FIG. 3, the laser beam 9 is in its initial position. The laser beam 9 is parameterized so that in this position it melts material from the joint 3 of the two parts to be joined 1, 2 down to the target welding-in depth 8. The oscillation superimposed on the feed movement causes the laser beam 9 to be initially swiveled to the left against the feed movement in FIG. 3. This swinging movement of the laser beam 9 creates the joint 3 down to the welding-in depth 8 and thus the weld zone 5 along the oscillation amplitude. FIG. 3 schematically shows a hot crack 10 which has formed during hardening of the molten material of the weld zone.

After the laser beam 9 reaches its second end position, shown on the left in FIG. 3, it swings back to its starting position. Since during the entire swinging-out movement of the laser beam 9 from its starting position to its second end position, the laser head together with the laser beam 9 has been moved along the joint 3 due to the feeding relative to the parts to be joined 1, 2, the speed with which the laser beam 9 is moved over the now solidified molten material of the weld zone 5 during the swing back movement is greater than during the swinging-out from its starting position. Consequently, when the laser beam 9 swings back, the line energy and thus the energy introduced by the laser beam 9 into the weld zone 5 is significantly lower than during the initial swinging out, which is why the weld zone 6 is formed with a correspondingly lower welding-in depth. This welding-in depth does not extend to the critical welding-in depth. This melting step heals hot cracks 10 formed during the first laser step.

The oscillation frequency of the laser beam 9 in the example shown is 20 Hz with an exemplary oscillation amplitude of 3 mm. This means that the speed of movement of the laser beam 9 as a result of its oscillation along the joint 3 is approximately twice as high as the feed rate at which the laser head is moved along the joint 3.

The feed rate, the oscillation frequency and the oscillation amplitude are set according to the material of the parts to be joined 1, 2 and the desired target welding-in depth.

FIG. 4 shows an exemplary embodiment of a welded construction 11 produced by the welding method described above. The welded construction 11 is a cross member of a bumper assembly for a motor vehicle. The welded construction 11 has two outer plates 12, 13, wherein the outer plate 12 is a front plate and the second outer plate 13 is a rear plate with respect to the arrangement relative to the vehicle. The two outer plates 12, 13 are connected to each other by two transverse plates 14, 15. In the embodiment shown, the material thickness of the transverse plates 14, 15 is approximately twice the material thickness of the outer plates 12, 13. The transverse plates 14, 15 adjoin the facing flat sides of the outer plates 12, 13 with their longitudinal joints. In this position, shown in FIG. 5, said components 12, 13, 14, 15 of the welded construction 11 are held by a clamping device, not shown, and preloaded so that the T-joints formed in each case between the transverse plates 14, 15 and the outer plates 12, 13 form a so-called zero gap. The components 12, 13, 14, 15 are welded by laser welding as described above. The welding of the respective parts to be joined is indicated by four laser beams 9 shown in FIG. 5. In this way, the weld seams of the welded construction 11 are free of cracks, which is why the welded construction 11 provided as a bumper crossmember easily meets the requirements placed on such a crossmember. In any case, the weld seams, which conventionally often represent the weak point in such welded constructions, no longer represent weak points.

The invention has been described with reference to exemplary embodiments. Without departing from the scope of the applicable claims, there are numerous further possible implementations of these embodiments by a person skilled in the art, without this having to be explained in further detail in the context of these explanations.

### LIST OF REFERENCE NUMERALS

1, 1.1 parts to be joined
2, 2.1 parts to be joined
3, 3.1 joint
4 weld seam
5, 5.1 weld zone
6 weld zone
7 hot crack
8 target welding-in depth
9 laser beam
10 hot crack
11 welded construction
12 outer plate
13 outer plate
14 transverse plate
15 transverse plate

1. A method for laser welding of two parts to be joined (1, 2; 12, 13, 14, 15) that are positioned in relation to one another, in which method the laser head with the laser beam (9) emitted from it and the two parts to be joined with their joint (3) are moved in relation to one another in a feeding direction along the longitudinal extent of the joint (3) and the laser beam (9) produces a weld seam in the joint (3) with a target welding-in depth (8) which is deeper than the critical welding-in depth of the parts to be joined (1, 2; 12, 13, 14, 15), characterized in that the welding method is performed in two steps and, to form the weld seam connecting the two parts to be joined (1, 2), in a first step, material in the joint (3) is melted by the laser beam (9) down to the target welding-in depth (8), and in that, in a subsequent step, the weld seam produced by the first step is melted once again down to a welding-in depth which, as a maximum, corresponds to the critical welding-in depth of the parts to be joined (1, 2; 12, 13, 14, 15).

2. The method according to claim 1, characterized in that the first step is performed with a laser beam of higher energy density emitted by a first laser head and the second step is performed with a laser beam of lower energy density emitted by a second laser head.

3. The method according to claim 2, characterized in that the second laser head follows the first laser head in the feeding direction, in that both laser heads are mounted on a common laser head holder or are also moved independently of one another and relative to the joint.

4. The method according to claim 1, characterized in that for performing the laser welding method the same laser head is used for the first and the second step, wherein the second step is performed with a reduced energy input.

5. The method according to any one of claims 1 to 4, characterized in that one or more intermediate welding steps are carried out after the first welding step and before performing the second welding step.

6. The method according to claim 4 or 5, characterized in that the laser head and the two parts to be joined (1, 2; 12, 13, 14, 15) are moved continuously with their joint relative to one another in the feeding direction, and in that the laser beam (9), starting from an initial position defined by an end point of the oscillating movement, in which it melts material down to the target welding-in depth (8), is swiveled in an oscillating manner initially counter to the feeding direction and then back into the initial position, wherein the feed rate of the laser beam (9), during such an oscillating movement, is higher than the feed rate at which the laser head and the joint (3) are moved relative to one another, and thus the swing back movement of the laser beam (9) into its starting position is responsible for carrying out the second step of the laser welding.

7. The method according to claim 6, characterized in that the laser beam is operated at constant power.

8. The method according to claim 6 or 7, characterized in that the oscillation frequency is between 5 Hz and 50 Hz.

9. The method according to any one of claims 6 to 8, characterized in that the oscillation amplitude of the laser beam 9 is not less than about 50% of the target weld-in depth (8).

10. The method according to any one of claims 1 to 9, characterized in that, before joining, the two parts to be joined (1, 2; 12, 13, 14, 15) are preloaded by a clamping device for positioning the parts to be joined (1, 2; 12, 13, 14, 15) in the joint (3).

11. The method according to any one of claims 1 to 10, characterized in that the welding method is used to weld together parts to be joined (1, 2; 12, 13, 14, 15) made of materials at risk of hot cracking.

12. A welded construction, in particular as an assembly for a motor vehicle, characterized in that at least some of the components of the assembly are welded to one another by the method according to any one of claims 1 to 11.

13. The welded construction according to claim 12, characterized in that at least two parts to be joined (1, 2; 12, 13, 14, 15) of the welded construction (11) are adjacent to each other in a T-joint.

14. The welded construction according to claim 12 or 13, characterized in that the weld seam for joining two parts to be joined (1, 2; 12, 13, 14, 15) of the welded construction (11) is one-sided with respect to the joint (3) and the welding-in depth is smaller than the material thickness of the one part to be joined (1; 14, 15), the end face of which rests against a side face of the other part to be joined (2; 12, 13).

15. The welded construction according to any one of claims 1 to 14, characterized in that the welded construction (11) is a hollow chamber profile beam with two spaced-apart outer plates (12, 13) and two transverse plates (14, 15) arranged between these plates (12, 13), wherein the abutments of the transverse plates (14, 15) respectively adjoin the mutually facing flat side of the outer plates (12, 13).

16. The welded construction according to claim 15, characterized in that the hollow section profile beam is a bumper cross member, in which one of the two outer plates (12) is the front plate facing away from a vehicle chassis and the other outer plate (13) is the rear plate facing towards a vehicle chassis.

17. The welded construction according to claim 15 or 16, characterized in that the two outer plates do not have a constant distance from each other over the length of the hollow chamber profile beam.

18. The welded construction according to claim 17, characterized in that the distance between the two outer plates is greater in the region of the beam center than in the beam end portions.

19. The welded construction according to claim 18, characterized in that the distance between the two plates continuously decreases from a central portion to the outer end portions.
